(19) United States
(12) Patent Application Publication
(10) Pub. No.: US 2006/0272187 A1
(43) Pub. Date: Dec. 7, 2006

(54) LIGHTED WALL PANEL

(76) Inventor: Gregory O. Mervine, Fishers, IN (US)

Correspondence Address: BARNES & THORNBURG LLP, 11 SOUTH MERIDIAN, INDIANAPOLIS, IN, 46204, US

(21) Appl. No.: 11/421,292

(22) Filed: May 31, 2006

Related U.S. Application Data
(60) Provisional application No. 60/686,641, filed on Jun. 2, 2005.

(51) Int. Cl. G09F 13/00

(52) U.S. Cl. 40/547

(57) ABSTRACT

A light system includes a lighted wall panel illuminated by an illuminator e control of a controller. The lighted wall panel includes an interior portion to mount an array of points of light and an exterior portion covering the interior to emit light released by the points of light.

This present application claims benefit of U.S. Provisional Patent Application Ser. No. 60/686,641, filed Jun. 2, 2005, which application is hereby incorporated by reference herein.

### BACKGROUND

The present disclosure relates to a wall panel and particularly to lighted wall panels. More particularly, the present disclosure relates to a lighted wall panel having a variable light and color emission.

### SUMMARY

A light system in accordance with the present disclosure includes a lighted wall panel illuminated by an illuminator under the control of a controller. The lighted wall panel includes an interior portion arranged to mount an array of points of light and an exterior portion covering the interior portion to emit light released by the points of light.

In illustrative embodiments, the illuminator includes a light source and a color palette so that various color patterns and images can be emitted by the array of points of light. The controller is also able to generate alphanumeric symbols across the array of points of light.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description below particularly refers to the accompanying figures in which:

FIG. 1 is a perspective view of a light system showing a number of lighted wall panels mounted to existing walls and ceilings, the lighted wall panels in communication with an illuminator;

FIG. 2 is a schematic view, with portions broken away, of the lighted wall panel of FIG. 1 showing a controller coupled to the illuminator, the illuminator coupled to the lighted wall panel and having a light source and a color palette;

FIG. 3 is a perspective view, with portions broken away, of a lighted wall panel coupled to a structural member to form at least a portion of a wall surface, showing fiber optic cables extending along a “corrugated” cable guide mounted to an interior portion of the lighted wall panel, the fiber optic cables extending between the illuminator and points of light (shown in phantom) coupled to a mount in an interior portion of the wall panel;

FIG. 4 is a sectional view, with portions broken away, taken along lines 4-4 of FIG. 1 showing the fiber optic cables extending through the interior portion of the wall panel and coupled to the points of light mounted between the mount and a diffuser, the wall panel further mounted to a wall surface; and

FIG. 5 is a sectional view, with portions broken away, taken along lines 5-5 of FIG. 1 showing the corrugated cable guide positioned to lie between the points of light mount and a rear surface, the rear surface further coupled to a portion of the wall surface.

### DETAILED DESCRIPTION

A light system 10 shown, for example, in FIG. 1 includes a lighted wall panel 12 illuminated by an illuminator 14 under the control of a controller 16. Panel 12 has a plurality of points 18 of light per unit area (e.g., 144 points/ft²) to emit light supplied by illuminator 14 according to a selected pattern of color and intensity.

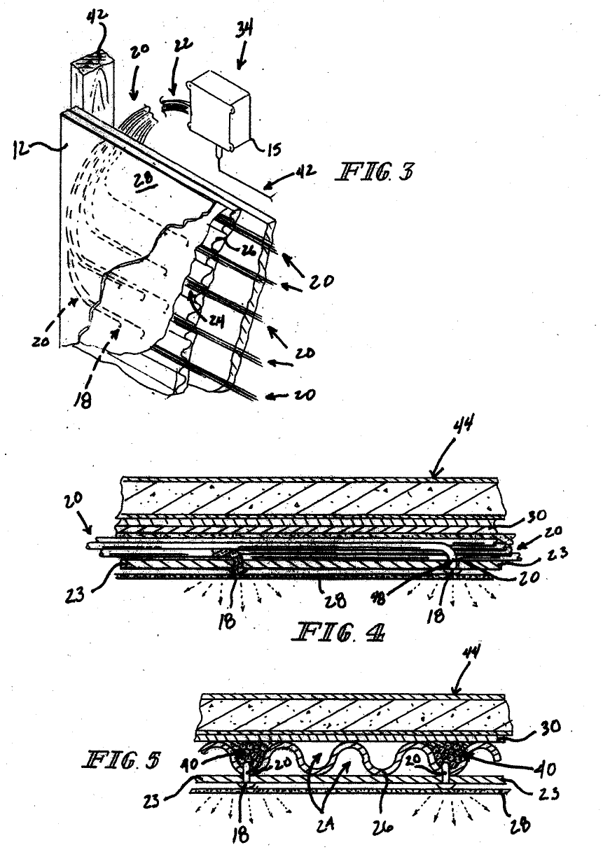

Illuminator 14 includes a housing 15, a light source 34 coupled to housing 15 and a color palette 17. Light is transmitted from illuminator 14 to panel 12 by a plurality of fiber optic cables 20, as shown, for example, in FIGS. 1-3. Points of light 18 are configured, for example, as end-lit filaments positioned along lines 20. Lines 20 exit a side 21 of panel 12 and are bundled to provide a harness 22 that connects to illuminator 14.

A virtually unlimited variety of patterns can be displayed by panel 12. For example, panel 12 can display solid patterns, variegated patterns, or other patterns. In addition, panel 12 can be used to display words in the form of messages such as holiday messages and religious verses and can be used to display pictures, sunrises, sunsets, to name just a few applications.

Such patterns may be stored in a memory of controller 16. The patterns may be stored, for example, at the factory during manufacture of system 10. Patterns may be downloaded into the memory from a portable memory device (e.g., compact disk or floppy disk) or from the Internet. In another example, an end user of panel 12 can create custom patterns to be stored in the memory of controller 16. The pattern displayed by panel 12 can be changed as frequently or infrequently as desired by the end user. Such lighting flexibility is useful for a number of purposes including, but not limited to, providing desired aesthetics and addressing health-related matters (e.g., “fighting” depression and/or providing vitamin D).

Referring now to FIG. 1, panel 12 may be mounted in a wide variety of locations. For example, panel 12 may be used to finish the interior or exterior of a structure. Panel 12 may be used to finish the vertical walls of a room, a floor, or a ceiling. In other examples, panel 12 may be used as part of a wireless room divider and may be used on exterior walls, on signs, billboards, and the like. Panel 12 may be used with newly constructed structures or in retrofit applications. Panel 12 may also be formed as a relatively narrow strip or other shape for use on trim, cabinets, appliances, and other devices.

Panel 12 includes an interior portion 21 formed to receive cables 20, a corrugated cable guide 26 and a point of light mount 23. Cables 20 extend within elongated channels 24 formed in corrugated cable guide 26, as shown, for example, in FIGS. 4 and 5. In this way, lines 20 are generally parallel to one another as they extend through panel 12. Illustratively, cables 20 are encased in a holding substrate 40 coupled to corrugated cable guide 26. Each cable 20 is bent slightly at second end 48 to extend through mount 23 to couple to point of light 18, as shown best in FIG. 4.

An exterior portion 28 covers lines 20 and points 18. Exterior portion 28 is configured to allow light to pass therethrough, as shown best in FIGS. 4 and 5. As such, exterior portion 28 may be transparent or a translucent diffuser. Exterior portion 28 may be made of a plastics material or other material permitting transmission of light therethrough. In other embodiments, exterior portion 28 may be opaque in which case points 18 may extend through openings in exterior portion 28. In still other embodiments, the exterior portion 28 may be omitted and a clear coating may be applied (e.g., by spraying or other technique) in place of exterior portion 28 over lines 20 and corrugated cable guide 26 so as to fill in recesses formed in one side of corrugated layer, thereby retaining lines 20 and cable guide 26 while allowing transmission of light through the coating. Such a clear coating may be acrylic that is air-brushed into place.

It is within the scope of this disclosure for panel 12 to include a backing sheet 30. In such a case, backing sheet 30 and exterior portion 28 sandwich lines 20 and corrugated cable guide 26 therebetween. Backing sheet 30 may be bonded (e.g., glue or other attachment adhesive), mechanically fastened, or otherwise coupled to the structure finished by panel 12. For example, backing sheet 30 may be coupled to wall studs 42, dry wall 44, ceiling joists, sub-flooring, to name just a few objects for receiving panel 12. Such objects may be made of wood, metal, or other suitable material for receiving panel 12. In retrofit applications, panel 12 can be used to cover existing walls. In the case where panel 12 is mechanically fastened to the structure finished thereby, decorative fasteners (not shown), for example, may be used. Backing sheet 30 may act as thermal insulation and/or a sound barrier. In other examples, an additional layer may be added for such purposes.

It is within the scope of this disclosure for source 14 to include a timer 50 in communication with controller 16 to determine the timing of operation of panel 12, as shown in FIG. 1. For example, timer 50 may be used to determine when panel 12 is turned “on” to emit light, turned “off” to stop emission of light, and/or when to switch the color palette in use. It is within the scope of this disclosure for timer 50 to be included in controller 16. It is further within the scope of this disclosure for the timer to be configured as an alarm clock that communicates with controller 16 and is separate from illuminator 14 and controller 16.

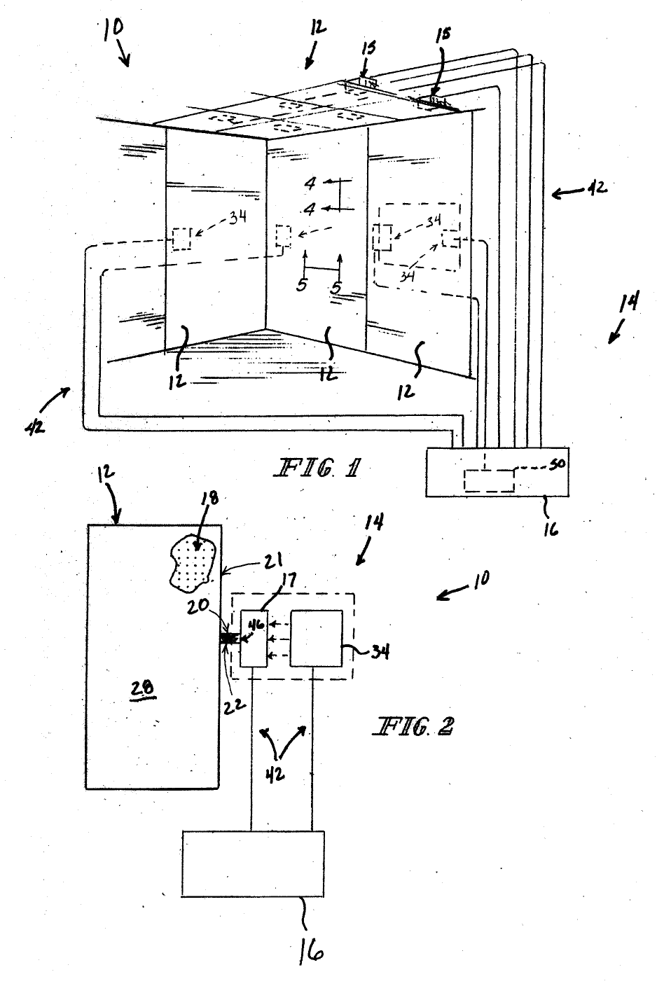

Controller 16 is coupled to illuminator 14 and color palette 17 via an electrical connection 42, as shown, for example, in FIG. 2. Such a connection 42 is “hard-wired” connection.

It is within the scope of this disclosure for controller 16 to communicate with illuminator 14 wirelessly. In such a case, illuminator 14 is configured to receive wirelessly command signals transmitted by controller 16. Such wireless communication may be achieved by a “wireless fidelity” system (i.e., a “Wi-Fi” system).

Means for coupling illuminator 14 to points of light 18 includes fiber optic cable 20 coupled to illuminator 14 on a first end 46 and coupled on a second end 48 to point of light 18. Illuminator 14 may be coupled to backing sheet 30. However, illuminator 14 may be positioned to lie in proximity to panel 12 depending on the length of fiber optic cable 20 used to couple illuminator 14 to panel 12.

1. A lighted wall panel comprising
a wall panel having an interior portion, points of light mounted in the interior portion, and an exterior portion,
an illuminator in communication with the wall panel, the illuminator having a housing, a light source coupled to the housing, and a color palette in communication with the light source, and
means for coupling the illuminator to the points of light so that when the light source is illuminated the points of light emit light from the illuminator.

2. The lighted wall panel of claim 1, wherein the coupling means includes a fiber optic cable coupled to each point of light on one end and further coupled to the illuminator on another end.

3. The lighted wall panel of claim 2, further comprising a controller in communication with the illuminator, wherein the controller, the illuminator, and the points of light cooperate to vary the intensity, color, hue, and pattern of light emitted from the wall panel.

4. The lighted wall panel of claim 2, wherein the exterior portion is made of a translucent material.

5. The lighted wall panel of claim 4, wherein the wall panel is configured to provide about 144 points of light per square foot, the points of light equidistantly positioned from one another to form an array.

6. The lighted wall panel of claim 5, wherein the array is able to emit solid patterns or variegated patterns of emitted light.

7. The lighted wall panel of claim 5, wherein the array is able to emit patterns of light in the form of alphanumeric characters.

8. The lighted wall panel of claim 1, further comprising a structure, and wherein the wall panel is coupled to the structure to form a wall, ceiling, and a floor.

9. A lighted wall panel comprising
a wall panel having an interior portion and an exterior portion, the exterior portion covering at least a portion of the interior portion,
an illuminator in communication with the wall panel, the illuminator having a housing, a light source coupled to the housing, a color palette in communication with the light source, and fiber optic cables coupled to the illuminator on a first end of each cable, and
an array of points of light mounted in the interior portion, each point of light coupled to a second end of the fiber optic cable and positioned to lie equidistantly to one another.

10. The lighted wall panel of claim 9, wherein the exterior portion is made of a translucent material.

11. The lighted wall panel of claim 10, wherein the wall panel is configured to provide about 144 points of light per square foot.

12. The lighted wall panel of claim 9, further comprising a controller in communication with the illuminator, wherein the controller, the illuminator, and the array of points of light cooperate to vary the intensity, color, and pattern of light emitted from the wall panel.

13. The lighted wall panel of claim 12, wherein the array is able to emit solid patterns or variegated patterns of emitted light.

14. The lighted wall panel of claim 12, wherein the array is able to emit patterns of light in the form of alphanumeric characters.

15. The lighted wall panel of claim 9, further comprising a structure, and wherein the wall panel is coupled to the structure to form a wall, ceiling, and a floor.

16. A lighted wall panel comprising
a wall panel having an interior portion, a mount formed in the interior portion, and a translucent exterior portion substantially covering the interior portion,
an illuminator in communication with the wall panel, the illuminator having a controller, a housing, a light source coupled to the housing, a color palette in communication with the light source, and fiber optic cables coupled to the illuminator on a first end of each cable, and
an array of points of light coupled to the mount, each point of light coupled to a second end of the fiber optic cable and positioned to lie equidistantly to one another.

17. The lighted wall panel of claim 16, wherein the exterior portion is made of a translucent material.

18. The lighted wall panel of claim 16, wherein the wall panel is configured to provide about 144 points of light per square foot.

19. The lighted wall panel of claim 16, wherein the array is able to emit solid patterns or variegated patterns of emitted light.

20. The lighted wall panel of claim 16, wherein the array is able to emit patterns of light in the form of alphanumeric characters.
